(19) United States
(12) Patent Application Publication
(10) Pub. No.: US 2007/0211483 A1
(43) Pub. Date: Sep. 13, 2007

(54) Vehicle interior illumination device

(75) Inventors: Yasuyuki Ando, Aichi-ken (JP); Seiichiro Mizoguchi, Aichi-ken (JP)

Correspondence Address: GANZ LAW, P.C., P O BOX 2200, HILLSBORO, OR, 97123, US

(73) Assignee: Kojima Press Industry Co. Ltd., Aichi-ken (JP)

(21) Appl. No.: 11/583,187

(22) Filed: Oct. 18, 2006

(30) Foreign Application Priority Data
Mar. 2, 2006 (JP) 2006-56837

(51) Int. Cl. B60Q 1/26

(52) U.S. Cl. 362/488

(57) ABSTRACT

A vehicle interior illumination device comprises: a housing secured to a vehicle interior; a light source secured to an inside of the housing; an illumination lens disposed on a surface on the vehicle interior side of the housing, which transmits light from the light source for illuminating the vehicle interior; an electrode formed as a thin film on a surface on the light source side of the illuminating lens; and an illuminating power control unit which is connected to the electrode, and which switches the light source power on and off based on changes in capacitance between the electrode and a person, which are caused by the person making contact with a vehicle interior side surface of the illuminating lens.

### CROSS-REFERENCE TO RELATED APPLICATIONS

The entire disclosure of Japanese Patent Application No. 2006-56837 including specifications, claims, drawings, and abstracts is incorporated herein by references.

### BACKGROUND OF THE INVENTION

1. Field of the Invention

The present invention relates to a vehicle interior illumination device which illuminates the interior of a vehicle.

2. Description of the Related Art

A vehicle interior illumination device for illuminating the interior of a vehicle is provided on the ceiling of the vehicle interior. FIG. 7A is a perspective view of a vehicle interior illumination device 1 in which a typical illumination lens 10 has been installed, and FIG. 7B is a cross-section of a switch section of the vehicle interior illumination device 1 in FIG. 7A. The switch of the vehicle interior illumination device 1 comprises a push button switch 60, which is positioned in the vicinity of the illumination section of the illumination device, and in which a push button 61 is connected to a push switch 62. However, the small push button 61 is difficult to locate in positions of poor visibility such as the ceiling of the vehicle interior, and operability is impaired. For this reason, a means by which improved operability of the push-down section is achieved by means of an integrated illumination section of the illumination device has been disclosed in Japanese Patent Laid-open Publication No. 2005-231518. FIG. 7C is a perspective view of a vehicle interior illumination device 1 provided with this type of push-down switch, and FIG. 7D is a cross-section of the illuminating section and switch section of FIG. 7C. As shown in FIG. 7C and FIG. 7D, the entire illuminating section 63 of the vehicle interior illumination device 1 functions as a switch. The illuminating section 63 shown in FIG. 7C and FIG. 7D is provided with a protruding part 64 on its surface, and is secured to a housing 3 in a freely rotatable manner by means of a hinge 65. A circuit board 18 is secured to the vehicle interior outside of the housing 3, and a light source 16 is secured to the circuit board 18. A push switch 62 is secured to the circuit board 18, and a connecting section 66, which is positioned on the side of the protruding part 64 of the illuminating section 63 on the light source side, connects to a push switch 62. Moreover, the construction is such that by pushing down on the illuminating section 63 in the vicinity of the protruding part 64, the push switch 62 can switch the light source power on and off. Because the power source can be turned on and off by pushing the surface of the illuminating section 63, the operating surface is larger, and operability is greatly improved. However, because this switch uses a seesaw construction whereby the illuminating section 63 rotates around the hinge 65, in order to turn the vehicle interior illumination device 1 on and off by means of the switch, it is necessary to push a particular section of the illuminating section 63, and operability is not greatly improved compared to the push button switch 60. Moreover, a switch having this kind of sliding section requires a gap between the moveable illuminating section 63 and its protective housing 3, so inferior design has been a problem.

In order to improve operability, a switch for a vehicle interior illumination device in which an auxiliary pressure sensitive switch is disposed in the area of the illumination section in order to widen the operating surface of the switch, has been proposed in Japanese Unexamined Patent Publication No. 2005-29164. However, because a switch section to increase the surface area for this kind of auxiliary switch is provided within the circumference of the illuminating device, a reduction in elegance of the design has been a problem.

As a means to solve these problems, there is a device where a transparent touch switch is provided on the illuminating surface. An extremely thin spacer (5 to 10 μm) is laid on the surface of the glass which comprises the base of the touch switch, a pliable film (a PET sheet of around 200 μm) is applied to this surface, and a transparent electrode grid called an ITO (Indium Tin Oxide) intersecting orthogonally lengthwise and widthwise, is provided on the surface of the glass and film. In a normal state, electricity does not flow due to the separation by the spacer, but when the film surface is touched, the pressure connects the electrodes of the glass and film surface and electricity flows. Furthermore, there is a vehicle interior illumination device 1 in which all the surfaces of the glass and film are comprised of transparent electrodes, forming a touch switch which is applied to the vehicle interior side of the illuminating lens 10 of the vehicle interior illumination device 1, and light source power is turned on and off by touching the illuminating lens 10. However, when a thin transparent electrode sheet is used on the surface in this way, people's fingernails may come into contact with the sheet, thereby damaging the electrode sheet, and the surface electrode sheet may be damaged by cleaning the surface and so on, so a shortened lifespan and also unstable operation have been a problem.

The present invention provides a vehicle interior illumination device having a switch with good visibility, a longer life, and stable operation.

### SUMMARY OF THE INVENTION

A vehicle interior illumination device according to the present invention comprises: a housing secured to a vehicle interior; a light source secured to an interior of the housing; an illumination lens disposed on a surface on the vehicle interior side of the housing, which transmits light from the light source for illuminating the vehicle interior; an electrode disposed on a surface on the light source side of the illuminating lens; and an illuminating power control unit which is connected to the electrode, and which switches the light source power on and off based on changes in capacitance between the electrode and a person, which are caused by the person making contact with a vehicle interior side surface of the illuminating lens. Here the electrode may be formed as a thin film on a section which transmits light from the illuminating lens. Moreover there may be further provided: an electrical circuit board which is secured to a surface on the vehicle exterior side of the housing, and is connected to the illuminating power control unit; and a connecting member which is an elastically deformable conductor which connects the circuit board and the electrode. Furthermore, the electrode may be formed from a conductive material as a thin film on a surface on a light source side of the illuminating lens, by means of printing, coating, vacuum deposition, or sputtering.

A vehicle interior illumination device according to the present invention comprises: a housing secured to a vehicle interior; a light source secured to an interior of the housing; an illumination lens disposed on a surface on a vehicle interior side of the housing, which transmits light from the light source for illuminating the vehicle interior; a conductive resin disposed on a surface on a light source side of the illuminating lens; and an illuminating power control unit which is connected to the conductive resin, and which switches the light source power on and off based on changes in capacitance between the conductive resin and a person, which are caused by the person making contact with a vehicle interior side surface of the illuminating lens. Here the conductive resin may be integrally formed with the illuminating lens by means of insert molding.

The vehicle interior illumination device according to the present invention demonstrates the effects of an easily visible switch, a longer life, and stable operation.

### BRIEF DESCRIPTION OF THE DRAWINGS

FIG. 1 is a cross-section of a vehicle interior illumination device according to a first embodiment of the present invention.

FIG. 2 is a perspective view of a vehicle interior illumination device according to the first embodiment of the present invention.

FIG. 3 is a diagram showing a power control circuit used in the embodiments of the present invention.

FIG. 4 is a cross-section of a vehicle interior illumination device according to a second embodiment of the present invention.

FIG. 5 is a cross-section of a vehicle interior illumination device according to a third embodiment of the present invention.

FIG. 6A is a plan view of an illumination lens of a vehicle interior illumination device according to a fourth embodiment of the present invention.

FIG. 6B is a cross-section of the vehicle interior illumination device shown in FIG. 6A.

FIG. 7A is a perspective view of a vehicle interior illumination device according to conventional technology, and a cross-section thereof.

FIG. 7B is a cross-section of the switch section of the vehicle interior illumination device shown in FIG. 7A.

FIG. 7C is a perspective view of a vehicle interior illumination device according to other conventional technology, and a cross-section thereof.

FIG. 7D is a cross-section of the illumination section and switch section of the vehicle interior illumination device shown in FIG. 7C.

### DETAILED DESCRIPTION OF THE PREFERRED EMBODIMENTS OF THE INVENTION

Hereunder preferred embodiments of the present invention will be described with reference to the appended drawings.

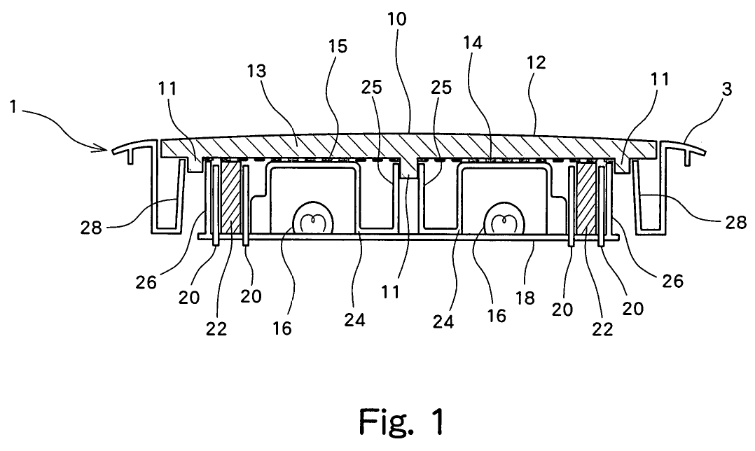

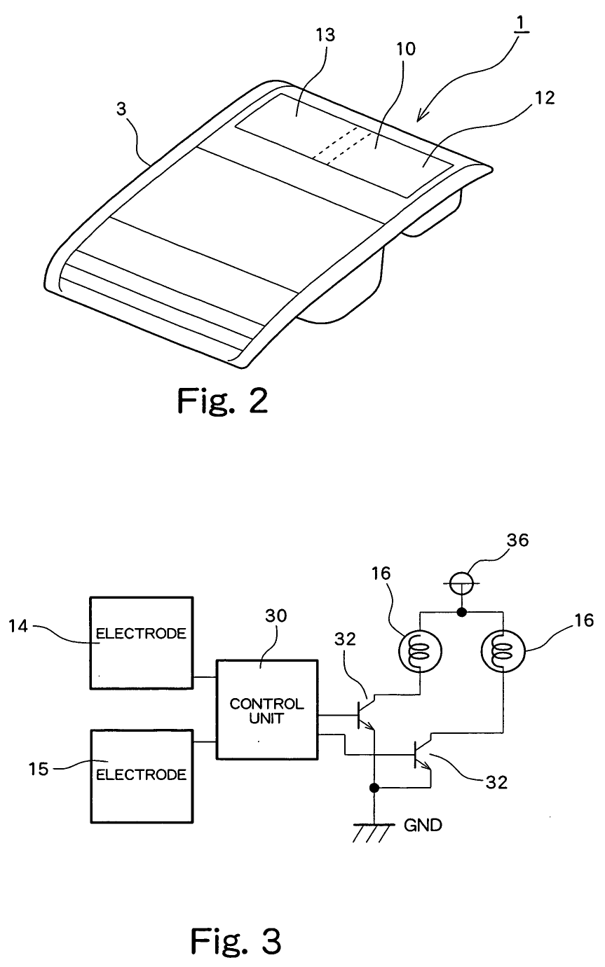

FIG. 2 is a perspective view of a vehicle interior illumination device 1 according to a first embodiment of the present invention, viewed from the side of the vehicle interior, and FIG. 1 is a cross-section of the illumination section of the vehicle interior illumination device 1 shown in FIG. 2. As shown in FIG. 2, the vehicle interior illumination device 1 is secured to the ceiling of a vehicle, and an illumination lens 10 is provided on the surface of the side of the vehicle interior. The illumination lens 10 contains transparent light transmitting sections 12 and 13 which illuminate the vehicle interior by transmitting the light of light sources 16 which are affixed to each housing interior section. As shown in FIG. 1, a housing 3 is provided on the left and right sides with an outside frame 28 and an inside frame 26, and a circuit board 18 comprising electrical wiring for the light source is affixed to the inside frame 26. The two light sources 16 are secured to the top of a circuit board 18, and a light source case 24 covers each light source 16. Each light source case 24 has a frame section 25. Furthermore, the illumination lens 10 is secured to the housing 3 by means of protruding sections 11 which protrude from the light source side of the illuminating lens 10 and fit perfectly between the outside frame 28 and the inside frame 26 of the housing 3, and also between the frame sections 25 of the light source case 24. Electrodes 14 and 15 are provided on the surface on the light source side of the illuminating lens 10, in between the protruding parts 11. Furthermore, on both sides of the circuit board 18 a structural section is formed by two holders 20, and a conductive bar 22 is affixed to the structural section between these holders 20. The conductive bar 22 is formed of a conductive elastic material such as conductive rubber, and is compressed between the electrodes 14 and 15 and the circuit board 18 to connect both sides, thereby electrically connecting the electrodes 14 and 15 and the circuit board 18.

All of the illuminating lens 10, the electrodes 14 and 15, and the light source cases 24 are transparent, and the light of the light source 16 passes from the light source 16 to the light source cases 24 and the electrodes 14 and 15, and is projected into the vehicle interior from the transparent light transmitting sections 12 and 13 of the illuminating lens 10, thereby illuminating the vehicle interior. The electrodes 14 and 15 are formed in a thin film on the surfaces on the light source side of the transparent light transmitting sections 12 and 13 by means of pressing, coating,.vapor deposition or sputtering a transparent conductive material. Furthermore, the electrodes 14 and 15 may be formed as a grid on the surfaces on the light source side of the transparent light transmitting sections 12 and 13 by means of pressing and so on of a non-transparent conductive material.

FIG. 3 is a diagram showing a power control circuit used in the embodiments of the present invention. As shown in FIG. 3, the electrodes 14 and 15 on the left and right are each connected from the circuit board 18 to a control unit 30. Capacitance (stray capacitance) exists between the conductors in the area around the metal parts of the electrodes 14 and 15 and the housing, and the metal parts of the circuit board and so on. As people are also conductive, capacitance (stray capacitance) also exists between a person and the electrodes 14 and 15, and when a person (finger) approaches the electrodes 14 and 15, the value of stray capacitance changes. The control unit 30 detects this change in the stray capacitance value, determines whether a touch has occurred, and when a touch has been determined it emits a specified output. The output of the control unit 30 is connected to the gates of light source drive transistors 32 which drive each of the light sources 16. The anodes of each of the light source drive transistors 32 are connected to a power source 36 via each of the light sources 16, and the cathodes are connected to an earthing terminal. A signal from the control unit 30 switches the flow of current to the gates of the light source drive transistors 32 on and off, thereby controlling the current from the power source 36 to the light sources 16. Due to the structure of the control unit 30, it is also possible to turn on both of the light sources 16 when one of the transparent light transmitting sections is touched by a person.

According to the present embodiment as described above, because it is possible to switch the power source of the light sources 16 on and off by means of a person touching the vehicle interior side of the illuminating lens 10, the detection area increases, and operability of the switch mechanism of the vehicle interior illumination device, which is in a low-visibility position, is improved. Moreover, because there is no electrical connecting section, an effect is demonstrated whereby stability of operation is increased. Furthermore, because there is no electrode sheet on the surface of the illuminating lens 10 where the person makes contact, an effect is demonstrated whereby a shortened lifespan due to damage to the electrode sheet caused by the contact of a person's fingernail, damage to the surface of the electrode sheet caused by cleaning the surface, and other operation faults can be reduced. Moreover, because the push button switch 61 is not necessary, an effect is demonstrated whereby it is possible to make the surface of the vehicle interior illumination device smoother, limitations on the design disappear, and improvements to the design can be devised.

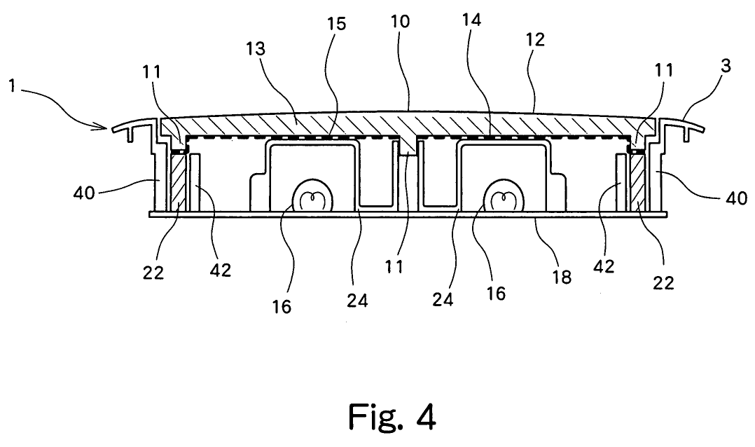

A second embodiment of the present invention will be described with reference to FIG. 4. Parts the same as in the first embodiment above are denoted by the same reference symbols, and description is omitted. FIG. 4 shows a device in which an outside frame 40 and an inside frame 42 are integrally formed on a housing 3, the circuit board 18 is secured to both frames, a conductive bar 22 is secured to the structure between both these frames, the conductive bar 22 is compressed into the gap between the circuit board 18 and the protruding parts 11 of the illuminating lens 10, and electrically connected, and the circuit board 18 and the electrodes 14 and 15 which are on the light source side of the illuminating lens 10 are conductive. Because of this, the electrodes 14 and 15 are also formed on the surface on the light source side of the protruding parts 11. Due to this structure, in addition to the effects of the first embodiment, it is possible to reduce the number of components, and an effect is demonstrated whereby the structure can be simplified.

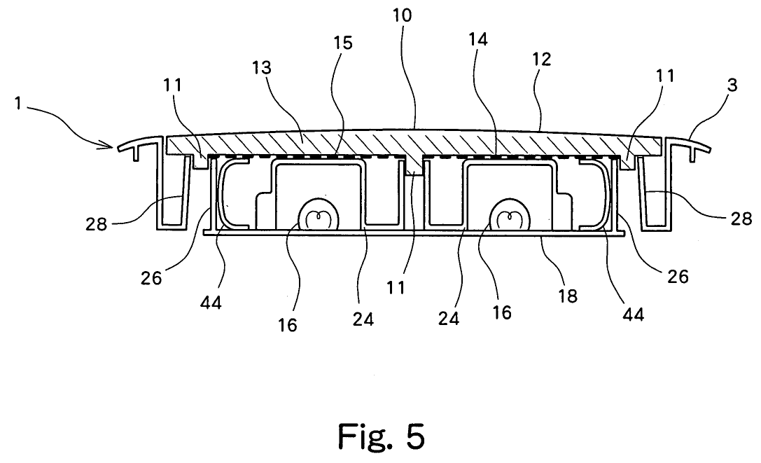

FIG. 5 shows a third embodiment. A flexible board 44 which is elastically deformable in a U-shape, contacts with the electrodes 14 and 15 and the circuit board 18 with an urging force to perform conduction. Due to this kind of structure, an effect is demonstrated in addition to the above effects of the first embodiment of the present invention, whereby further simplification of the structure is made possible.

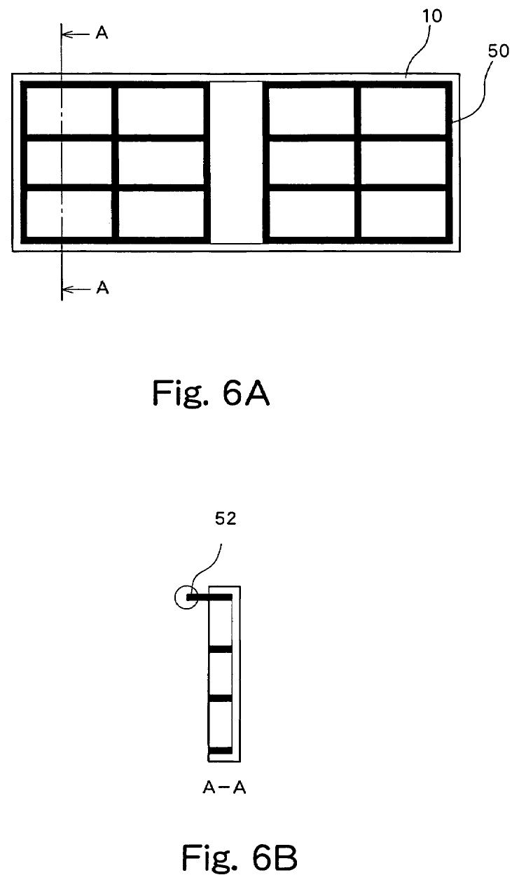

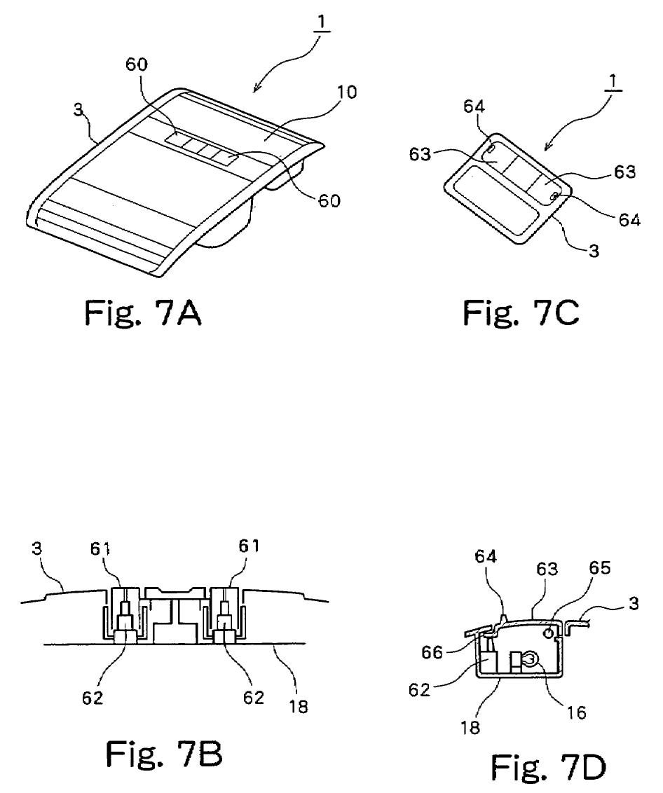

FIG. 6A is a plan view of an illumination lens of a vehicle interior illumination device according to a fourth embodiment of the present invention, and FIG. 6B is a cross-section thereof. In this embodiment electrodes are constructed in a grid by means of a conductive resin 50 on the surface on the light source side of the illuminating lens 10, instead of the electrodes 14 and 15. This conductive resin is integrally formed by means of insert molding and the like with the transparent illuminating lens 10. Even in the case where an opaque conductive resin can be seen from the surface of the illuminating lens 10, by forming cuts or the like in the surface of the illuminating lens 10 it becomes possible to improve the attractiveness of the design. Furthermore, similar effects can be obtained even when a light diffusing material is included as part of the illuminating lens 10. Moreover, by extending one part of the conductive resin 50 to form a conductive bar 52, and connecting this conductive bar 52 to the circuit board 18, it is possible to make the conductive resin 50 and the circuit board 18 conductive. According to this embodiment, an effect is demonstrated whereby the conductive resin 50 is combined by means of integral formation and a complete structure becomes simple. If a transparent conductive resin is used for the conductive resin 50, an effect is demonstrated whereby freedom of design increases even more. It is also possible to construct the illuminating lens 10 itself as a transparent conductive resin.

What is claimed is:

1. A vehicle interior illumination device comprising:
a housing secured to a vehicle interior;
a light source secured to an inside of said housing;
an illumination lens disposed on a surface on the vehicle interior side of said housing, which transmits light from said light source for illuminating said vehicle interior;
an electrode disposed on the surface on the light source side of said illuminating lens; and
an illuminating power control unit which is connected to said electrode, and which switches said light source power on and off based on changes in capacitance between said electrode and a person, which are caused by said person making contact with a vehicle interior side surface of said illuminating lens.

2. A vehicle interior illumination device according to claim 1, wherein said electrode is formed as a thin film on a section which transmits light from said illuminating lens.

3. A vehicle interior illumination device according to claim 1, wherein there is further provided:
an electrical circuit board which is secured to a surface on the vehicle exterior side of said housing, and is connected to said illuminating power control unit; and
a connecting member which is an elastically deformable conductor which connects said circuit board and said electrode.

4. A vehicle interior illumination device according to claim 1, wherein said electrode is formed from a conductive material as a thin film on a surface on a light source side of said illuminating lens, by means of printing, coating, vacuum deposition, or sputtering.

5. A vehicle interior illumination device comprising:
a housing secured to a vehicle interior;
a light source secured to an inside of said housing;
an illumination lens disposed on a surface on a vehicle interior side of said housing, which transmits light from said light source for illuminating said vehicle interior;
a conductive resin disposed on a surface on a light source side of said illuminating lens; and
an illuminating power control unit which is connected to said conductive resin, and which switches said light source power on and off based on changes in capacitance between said conductive resin and a person, which are caused by said person making contact with a vehicle interior side surface of said illuminating lens.

6. A vehicle interior illumination device according to claim 5, wherein said conductive resin is integrally formed with said illuminating lens by means of insert molding.
